(19) United States
(12) Patent Application Publication
(10) Pub. No.: US 2026/0364585 A1
(43) Pub. Date: Nov. 19, 2026

(54) POROGEN NANOCATALYST POLYMERIC COATING FOR OPTICAL FIBERS

(71) Applicants: Paul K. Westerhoff, Scottsdale, AZ (US); Han Fu, Rosemead, CA (US)

(72) Inventors: Paul K. Westerhoff, Scottsdale, AZ (US); Han Fu, Rosemead, CA (US)

(21) Appl. No.: 19/676,476

(22) Filed: May 13, 2026

Related U.S. Application Data
(60) Provisional application No. 63/805,069, filed on May 13, 2025.

(51) Int. Cl. B01J 35/39; B01J 21/06; B01J 23/02; B01J 35/45; B01J 35/64; C03C 25/106; G02B 1/04

(52) U.S. Cl. CPC B01J 35/39; B01J 21/063; B01J 23/02; B01J 35/45; B01J 35/647; B01J 35/651; C03C 25/106; G02B 1/048; C03C 2218/111; C03C 2218/32

(57) ABSTRACT

A photocatalytic optical fiber includes an optical fiber and a photocatalytic coating on the optical fiber photocatalytic coating defines pores and includes a particulate photocatalyst. A majority of the pores have a pore size of less than 100 nm. Coating an optical fiber includes contacting the optical fiber with a photocatalytic slurry to yield a coated optical fiber and contacting the coated optical fiber with an aqueous solvent to form a photocatalytic optical fiber. The photocatalytic slurry includes a first polymer, a second polymer, a photocatalyst, and a solvent including a polar organic solvent. The first polymer is soluble in an aqueous solvent and the polar organic solvent, and the second polymer is soluble in the polar organic solvent.

### CROSS-REFERENCE TO RELATED APPLICATION

This application claims the benefit of U.S. Patent Application No. 63/805,069 filed on May 13, 2025, which is incorporated by reference herein in its entirety.

### STATEMENT OF GOVERNMENT INTEREST

This invention was made with government support under 1449500, 2315479 awarded by the National Science Foundation and under 80NSSC23PB439 awarded by the National Aeronautics and Space Administration. The government has certain rights in the invention.

### TECHNICAL FIELD

This invention relates to optical fiber coatings.

### BACKGROUND

Various photocatalytic systems can be used in pollutant degradation, microbial disinfection, and sustainable resource production (e.g., H₂ and H₂O₂).

### SUMMARY

This disclosure describes preparing a photocatalytic slurry and a method of forming a porous photocatalytic coating on optical fibers (e.g., surface-emitting optical fibers). The photocatalytic slurry includes a photocatalyst, two polymers, and an organic solvent. In the photocatalytic slurry, a first polymer acts as a templating or sacrificial agent that is later removed, leaving behind a porous structure. The first polymer is soluble in an aqueous solvent and organic solvents, and the second polymer is soluble in organic solvents. The method of forming a porous photocatalytic coating on the surface of optical fibers includes contacting the optical fibers with the photocatalytic slurry. After contacting the optical fibers with the photocatalytic slurry, the optical fibers are contacted with an aqueous solvent, dissolving the first polymer and forming pores in the coating. The pores can improve accessibility of photocatalytic active sites for reactants or pollutants in water or air to enable light-driven applications.

The deposition of photocatalytic coatings on surface-emitting optical fibers affects their performance. For example, the thickness of the photocatalytic coating impacts diffusion of reactants and products from the external environment (e.g., air or water) to the optical fibers. The thickness of the coating can also impact light energy absorption within the optical fibers. This disclosure describes a porogen approach, which tunes the size and number of pores and the thickness of the coating layer. The porogen coating can prevent release (e.g., loss) of photocatalysts from the optical fiber surface.

In a first general aspect, a photocatalytic slurry includes a first polymer, a second polymer, a photocatalyst, and a solvent including a polar organic solvent. The first polymer is soluble in an aqueous solvent and the polar organic solvent, and the second polymer is soluble in the polar organic solvent.

Implementations of the first aspect can include one or more of the following features.

In some cases, the first polymer includes poly(vinyl pyrrolidone), polymethyl methacrylate, or both. In certain cases, the second polymer includes poly(vinylidene fluoride), polyethylene glycol, or both. The photocatalyst can include titanium dioxide particles or aluminum-doped strontium titanate particles. In some implementations, the solvent includes dimethylacetamide N,N-dimethylformamide, or both. The first general aspect can further include an additional solvent. The additional solvent can include acetone. In some cases, the photocatalytic slurry includes 1 wt % to 5 wt % of the photocatalyst. In certain implementations, a weight ratio of the first polymer to the second polymer is in a range of 1:1 to 1:5.

In a second general aspect, coating an optical fiber includes contacting the optical fiber with the photocatalytic slurry of the first general aspect.

Implementations of the second general aspect can include one or more of the following features.

Contacting the optical fiber with the photocatalytic slurry of the first general aspect can include dipping the optical fiber in the photocatalytic slurry to yield a coated optical fiber. In some cases, the second general aspect further includes contacting the coated optical fiber with the aqueous solvent, thereby dissolving the first polymer in the aqueous solvent and forming a photocatalytic optical fiber. Implementations of the second general aspect can further include drying the photocatalytic optical fiber. In some cases, drying the photocatalytic optical fiber includes heating to a temperature between 60 °C and 90 °C.

In a third general aspect, a photocatalytic optical fiber includes an optical fiber and a photocatalytic coating on the optical fiber. The photocatalytic coating defines pores and includes a particulate photocatalyst, and a majority of the pores have a pore size of less than 100 nm.

Implementations of the third general aspect can include one or more of the following features.

In some cases, the particulate photocatalyst includes titania. The particulate photocatalyst can include aluminum-doped strontium titanate. In certain cases, the photocatalytic coating includes poly(vinylidene fluoride). In some implementations, the photocatalytic coating includes a residual amount of poly(vinyl pyrrolidone).

In a fourth general aspect, a photocatalytic reactor includes one or more of the photocatalytic optical fibers of the third general aspect and a light source optically coupled to one or more of the one or more photocatalytic optical fibers. The light source is configured to radiate UV-A or visible light.

Implementations of the fourth general aspect can include the following feature.

In some cases, the light source includes a light emitting diode.

Photocatalytic slurry reactors can suffer from inefficient light utilization due at least in part to medium scattering, catalyst aggregation, and challenges in catalyst separation and recovery. These limitations can result in lower quantum yields and higher energy consumption. Photocatalyst-coated surface-emitting optical fibers can leverage both refracted light and evanescent waves to increase or maximize light utilization. This dual mechanism can improve reaction rates while minimizing energy losses. Surface-emitting optical fibers can also be used in decentralized systems, providing tailored light penetration and distribution even in geometrically complex environments.

The details of one or more embodiments of the subject matter of this disclosure are set forth in the accompanying drawings and the description. Other features, aspects, and advantages of the subject matter will become apparent from the description, the drawings, and the claims.

### BRIEF DESCRIPTION OF DRAWINGS

FIG. 1A is a schematic diagram illustrating an example of a photocatalytic optical fiber. FIG. 1B is a cross-sectional view of the photocatalytic optical fiber of FIG. 1A.

FIG. 2A is a schematic diagram of the photocatalytic water splitting system and H₂/O₂ production via modified strontium titanate (STO). FIG. 2B shows H₂ generation rates over two hours for surface-emitting optical fiber samples, including polyvinylidene fluoride (PVDF)/polyvinylpyrrolidone (PVP)-coated surface-emitting optical fibers, PVDF/PVP/STO-coated surface-emitting optical fibers, and samples prepared with different dipping times.

### DETAILED DESCRIPTION

This disclosure describes photocatalytic optical fibers and methods of fabricating the photocatalytic optical fibers for their application in light-driven processes. Forming a photocatalytic optical fiber includes contacting an optical fiber with a photocatalytic slurry to yield a coated optical fiber and contacting the coated optical fiber with an aqueous solvent (e.g., water) to yield the photocatalytic optical fiber.

The photocatalytic slurry includes a first polymer soluble in an aqueous solvent and an organic solvent, a second polymer soluble in an organic solvent, a photocatalyst, and an organic solvent. As used herein, a polymer is “soluble” in a solvent when a solution of at least 10 wt % of the polymer in the solvent can be formed (e.g., at room temperature). A weight ratio of the first polymer to the second polymer is in a range of 1:1 to 1:5 (e.g., 1:2). The first and second polymers are combined with a photocatalyst (e.g., TiO₂, aluminum-doped strontium titanate, metal-organic frameworks, or metal oxides) to yield the photocatalytic slurry. The optical fiber is contacted with the photocatalytic slurry to coat the optical fiber. The coated optical fiber is contacted with an aqueous solvent, thereby dissolving the first polymer in the aqueous solvent and forming the photocatalytic optical fiber. The photocatalytic optical fiber is dried (e.g., in air or in a heated chamber). In some cases, drying the photocatalytic optical fiber includes heating the photocatalytic optical fiber to a temperature between 60 °C and 90 °C. The photocatalytic coating creates pores that chemicals can diffuse into, allowing light-enabled photocatalytic reactions to proceed. Different photocatalysts in the porous cladding demonstrate the ability to produce hydrogen or hydrogen peroxide. The photocatalytic coating can secure photocatalysts, preventing their release (e.g., loss). This process can facilitate high throughput manufacturing of optical fibers for use in various applications in which photocatalysis is used to purify air and water or produce chemicals.

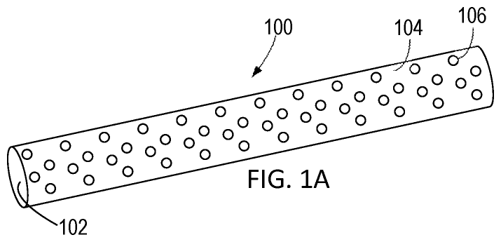

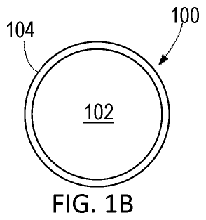

FIG. 1A is a schematic diagram illustrating an example of a photocatalytic optical fiber 100 and FIG. 1B is a cross-sectional view of the photocatalytic optical fiber 100. The photocatalytic optical fiber 100 includes an optical fiber 102 and a photocatalytic coating 104 including a particulate photocatalyst. The optical fiber 102 is a surface emitting-optical fiber. That is, the optical fiber 102 does not have an optically opaque cladding. Referring to FIG. 1A, the photocatalytic coating 104 defines a plurality of pores 106. A majority of the plurality of pores 106 (e.g., greater than 50%) have a pore size of less than 100 nm as determined by visual inspection of scanning electron microscope (SEM) images.

The photocatalytic coating 104 can act as a molecular sieve, allowing water and other small molecules to diffuse into the photocatalytic coating 104 where light-driven reactions can occur to produce products. Reaction products and byproducts can diffuse out of the photocatalytic coating 104 and away from the surface of the photocatalytic optical fiber 100 through the pores of the photocatalytic coating 104. This structure enables light-driven reactions in both aqueous and gas-phase environments by allowing diffusion of products and byproducts away from the surface of the photocatalytic optical fiber 100 to maintain high reaction rates.

### EXAMPLES

To prepare the polyvinylidene fluoride(PVDF)/ polyvinylpyrrolidone (PVP)/photocatalyst slurry, PVDF and PVP were dissolved in a N,N-dimethylacetamide(DMAc)/acetone mixture (1:1 v/v) at a PVDF: PVP weight ratio of 12:6. In the PVDF/PVP/photocatalyst slurry, 4 wt % TiO₂ or a modified STO was added. The mixture was sonicated in a water bath (5510, Branson, USA) for 1 hour and vigorously stirred at 60 °C for 24 hours until complete dissolution of PVDF and PVP. The slurry was cooled to room temperature before use. Two representative photocatalysts were used: a TiO₂ to assess photocatalysis accessibility via methylene blue adsorption and STO designed for H₂ generation via photocatalytic water splitting. TiO₂ AEROXIDE P25 was obtained from Evonik Industries, Germany. To synthesize STO, SrCl₂, Al₂O₃, and SrTiO₃ were mixed in a 10:0.02:1 molar ratio, ground in an agate mortar, and annealed in an alumina crucible at 1,423 K for 10 hours in air. The resulting aluminum-doped strontium titanate (SrTiO₃:Al) was washed with distilled water until a neutral pH was achieved, filtered, and dried at 313 K for 6 hours. Cocatalysts Rh/Cr₂O₃ and CoOOH were stepwise photo-deposited onto SrTiO₃:Al by dispersing 0.1 g of SrTiO₃:Al in 100 mL of distilled water. Aqueous solutions of RhCl₃, K₂CrO₄, and Co(NO₃)₂ were sequentially added under 300 W Xe lamp irradiation for 10 minutes, 5 minutes, and 5 minutes, respectively, to achieve 0.1 wt % Rh, Cr, and Co deposition. The final product was filtered and dried overnight at 60 °C.

Any commercially available surface-emitting optical fibers can be used. The surface-emitting optical fibers can include polymeric optical fibers (e.g., polymethyl methacrylate (PMMA) or polycarbonate cores) or silica-based glass fibers. Furthermore, the fiber diameter and geometry can be varied (e.g., ranging from micrometers to several millimeters) to accommodate the specific flexibility requirements and scale of the target photocatalytic reactor. In an example, the surface-emitting optical fibers were obtained from Mitsubishi Chemical Eska Optical Fiber (CK-120, Japan) and cut into fibers measuring 16 cm in length. The surfaces at both ends of each fiber were polished using five grades of optical polishing paper (LE30D, LE5P, LE3P, LE1P, and LE03P, Thorlabs™) until achieving a smooth, mirror-like finish.

PVDF/PVP/photocatalyst slurry coatings on surface-emitting optical fibers were fabricated using a dip-coating method. 20 mL PVDF/PVP/photocatalyst slurry was added to a 25 mL volumetric cylinder. The surface-emitting optical fibers were dipped into the slurry and quickly withdrawn. The dip-coating process was repeated one to four times. Subsequently, the coated surface-emitting optical fibers were immersed in purified water overnight to remove water-soluble PVP. The PVDF/PVP/photocatalyst-coated surface-emitting optical fibers were dried at 60 °C for 1 hour. For comparison, PVDF/PVP-coated surface-emitting optical fibers (without any photocatalyst) were prepared using the same method (dip-coating 1 time) and PVP was removed via submerging into purified water. PVDF/photocatalyst-coated surface-emitting optical fibers were prepared using the same method (dip-coating 1 time). While this example utilizes PVDF and PVP, alternative structural polymers (e.g., polymethyl methacrylate PMMA) and water-soluble porogens (e.g., polyethylene glycol (PEG)) may be substituted. Additionally, other polar organic solvents such as N,N-dimethylformamide (DMF) can be used to appropriately tune the coating viscosity and pore size.

Methylene blue (MB) was used as a probe to evaluate the accessibility of PVDF/photocatalyst surface sites. A 50 mL solution of MB (1.5 mg/L) was prepared, and PVDF/TiO₂-coated surface-emitting optical fibers were dipped into the MB solution, quickly withdrawn, and air-dried for 1 hour. Accessibility was compared by capturing images of the coated surface-emitting optical fibers.

The hydrogen generation rate using PVDF/STO-coated surface-emitting optical fibers was measured in a vertical glass cylinder reactor. The PVDF/STO-coated surface-emitting optical fibers and a 5 W monochromatic UV-light LED (λ=365 nm, operating at 0.7 A and 3.2 V, Shenzhen Yunju Electronics Co., Ltd.) were positioned at the bottom of the reactor. Hydrogen gas samples were collected from the top of the reactor every 30 minutes and quantified using a gas chromatograph (Shimadzu GC 2010).

Various surface-emitting optical fiber samples were assessed after methylene blue surface dyeing. Comparing the bare surface-emitting optical fiber sample and the PVDF/PVP-coated surface-emitting optical fiber sample, negligible color changes were observed, suggesting negligible deposition of methylene blue on the surface-emitting optical fiber surface or the PVDF/PVP-coated surface. PVDF/TiO₂-coated surface-emitting optical fibers were exposed to a methylene blue solution. Increased color changes were observed when compared to the bare surface-emitting optical fiber and PVDF/PVP-coated surface-emitting optical fiber sample, suggesting successful methylene blue adsorption onto the TiO₂ content in the PVDF/TiO₂ coating. Negligible color differences were observed for surface-emitting optical fibers subjected to one to four dips in the methylene solution, suggesting that methylene blue molecules access the surface of PVDF/TiO₂₋coated surface-emitting optical fibers with negligible penetration, due at least in part to the absence of a porous structure.

The PVDF/PVP/TiO₂-coated surface-emitting optical fiber after dipping once in the methylene blue solution had a darker color compared to the bare surface-emitting optical fiber sample, the PVDF-PVP-coated surface-emitting optical fiber sample, and the PBDF-TiO₂ surface-emitting optical fiber sample. This suggested that in the PVDF/PVP/TiO₂-coated surface-emitting optical fiber sample, methylene blue molecules were able to diffuse into the porous channels formed by the PVP and access more TiO₂ in contact with the surface-emitting optical fiber surface. Given the molecular size of methylene blue (14.38 Å) compared to water molecules (2.75 Å), hydrogen molecules (0.72 Å), and oxygen molecules (1.21 Å), this porous structure can be expected to enhance photocatalytic water splitting by facilitating efficient access of reactants to the catalyst surface and evacuation of hydrogen and oxygen products.

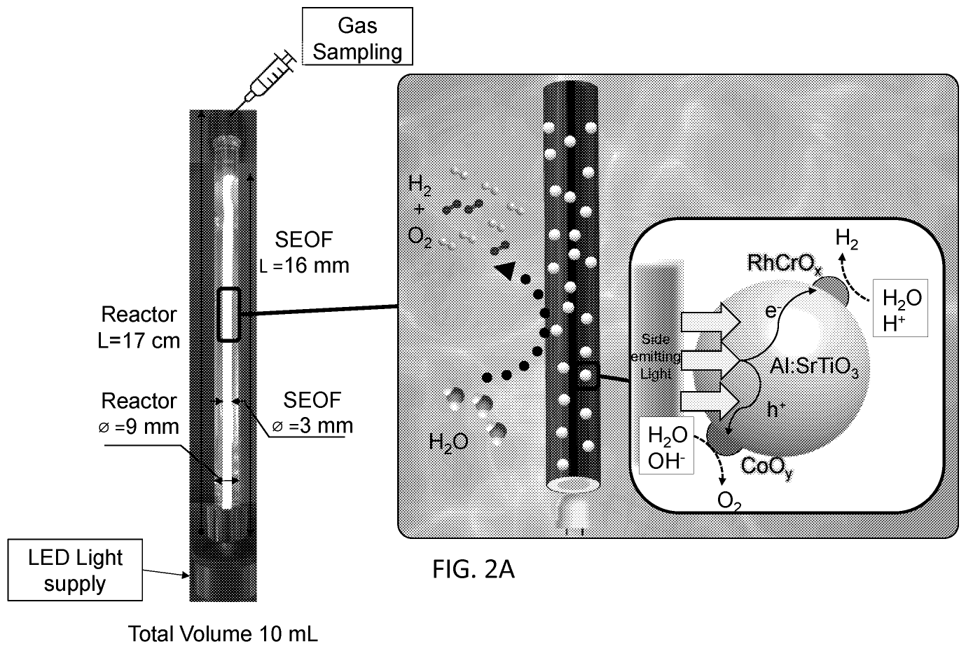

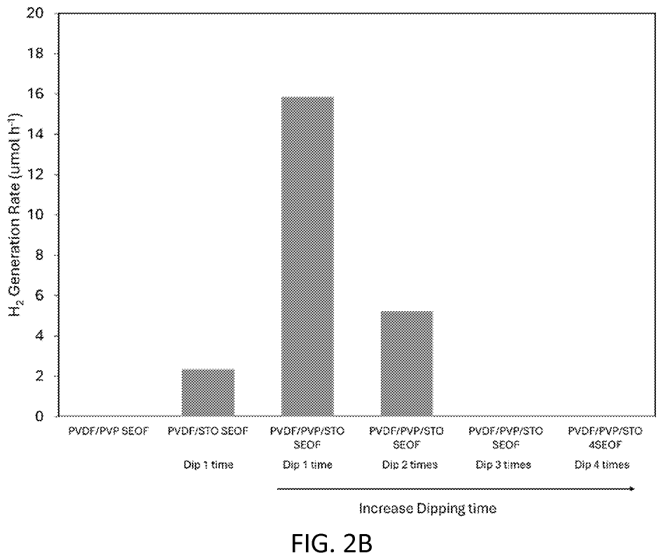

FIG. 2A is a schematic diagram of a photocatalytic water splitting system, including H₂ and O₂ production via an aluminum-doped strontium titanate. FIG. 2B shows the photocatalytic H₂ generation over two hours with different surface-emitting optical fiber samples, analyzed using zero-order kinetics. The PVDF/PVP-coated surface-emitting optical fiber exhibits negligible H₂ production, suggesting that neither PVDF nor surface-emitting optical fiber material contribute to water splitting independently. The PVDF/PVP/STO-coated surface-emitting optical fibers achieve an H₂ production rate of approximately 16 μmol h⁻¹, nearly eight times higher than PVDF/PVP-coated surface-emitting optical fibers, suggesting that the PVP porogen can play a role in forming a porous structure. These results support the methylene blue accessibility assessment, where PVDF/PVP/TiO₂-coated surface-emitting optical fibers demonstrated improved methylene blue adsorption compared to PVDF/TiO₂-coated surface-emitting optical fibers.

Additionally, FIG. 2B compared the H₂ generation rates of PVDF/PVP/STO-coated surface-emitting optical fibers prepared with 1 to 4 dip coatings in the methylene blue solution. The results suggested that improved performance was achieved with a single dip coating, as an increased number of dip coatings led to a decrease in H₂ production rates. Notably, production of H₂ was not detected for 3 and 4 dip coatings. This decline can be attributed at least in part to excessive PVDF deposition, which blocks light penetration and hinders the efficient evacuation of H₂ and O₂ products. These findings highlight that a single dip coating can provide a balance between coating uniformity and maintaining the porous structure, promoting improved performance of the PVDF/PVP/STO-coated surface-emitting optical fibers.

Although this disclosure contains many specific embodiment details, these should not be construed as limitations on the scope of the subject matter or on the scope of what may be claimed, but rather as descriptions of features that may be specific to particular embodiments. Certain features that are described in this disclosure in the context of separate embodiments can also be implemented, in combination, in a single embodiment. Conversely, various features that are described in the context of a single embodiment can also be implemented in multiple embodiments, separately, or in any suitable sub-combination. Moreover, although previously described features may be described as acting in certain combinations and even initially claimed as such, one or more features from a claimed combination can, in some cases, be excised from the combination, and the claimed combination may be directed to a sub-combination or variation of a sub-combination.

Particular embodiments of the subject matter have been described. Other embodiments, alterations, and permutations of the described embodiments are within the scope of the following claims as will be apparent to those skilled in the art. While operations are depicted in the drawings or claims in a particular order, this should not be understood as requiring that such operations be performed in the particular order shown or in sequential order, or that all illustrated operations be performed (some operations may be considered optional), to achieve desirable results.

Accordingly, the previously described example embodiments do not define or constrain this disclosure. Other changes, substitutions, and alterations are also possible without departing from the spirit and scope of this disclosure.

What is claimed is:

1. A photocatalytic slurry comprising:
a first polymer;
a second polymer;
a photocatalyst; and
a solvent comprising a polar organic solvent,
wherein the first polymer is soluble in an aqueous solvent and the polar organic solvent, the second polymer is soluble in the polar organic solvent.

2. The photocatalytic slurry of claim 1, wherein the first polymer comprises poly(vinyl pyrrolidone), polymethyl methacrylate, or both.

3. The photocatalytic slurry of claim 1, wherein the second polymer comprises poly(vinylidene fluoride), polyethylene glycol, or both.

4. The photocatalytic slurry of claim 1, wherein the photocatalyst comprises titanium dioxide particles or aluminum-doped strontium titanate particles.

5. The photocatalytic slurry of claim 1, wherein the solvent comprises dimethylacetamide N,N-dimethylformamide, or both.

6. The photocatalytic slurry of claim 1, further comprising an additional solvent, wherein the additional solvent comprises acetone.

7. The photocatalytic slurry of claim 1, wherein the photocatalytic slurry comprises 1 wt % to 5 wt % of the photocatalyst.

8. The photocatalytic slurry of claim 1, wherein a weight ratio of the first polymer to the second polymer is in a range of 1:1 to 1:5.

9. A method of coating an optical fiber, the method comprising:
contacting the optical fiber with the photocatalytic slurry of claim 1.

10. The method of claim 9, wherein contacting the optical fiber with the photocatalytic slurry of claim 1 comprises dipping the optical fiber in the photocatalytic slurry to yield a coated optical fiber.

11. The method of claim 10, further comprising contacting the coated optical fiber with the aqueous solvent, thereby dissolving the first polymer in the aqueous solvent and forming a photocatalytic optical fiber.

12. The method of claim 11, further comprising drying the photocatalytic optical fiber.

13. The method of claim 12, wherein drying the photocatalytic optical fiber comprises heating to a temperature between 60 °C and 90 °C.

14. A photocatalytic optical fiber comprising:
an optical fiber; and
a photocatalytic coating on the optical fiber, wherein the photocatalytic coating defines pores and comprises a particulate photocatalyst, wherein a majority of the pores have a pore size of less than 100 nm.

15. The photocatalytic optical fiber of claim 14, wherein the particulate photocatalyst comprises titania.

16. The photocatalytic optical fiber of claim 14, wherein the particulate photocatalyst comprises aluminum-doped strontium titanate.

17. The photocatalytic optical fiber of claim 14, wherein the photocatalytic coating comprises poly(vinylidene fluoride).

18. The photocatalytic optical fiber of claim 14, wherein the photocatalytic coating comprises a residual amount of poly(vinyl pyrrolidone).

19. A photocatalytic reactor comprising:
one or more of the photocatalytic optical fibers of claim 14; and
a light source optically coupled to one or more of the one or more photocatalytic optical fibers, wherein the light source is configured to radiate UV-A or visible light.

20. The photocatalytic reactor of claim 19, wherein the light source comprises a light emitting diode.
